(19) United States
(12) Patent Application Publication
(10) Pub. No.: US 2026/0250905 A1
(43) Pub. Date: Aug. 27, 2026

(54) MECHANICAL SOFTENING OF PRINTED FABRICS

(71) Applicant: Kornit Digital Ltd., Rosh HaAyin (IL)

(72) Inventor: Ohad SNIR, Kiryat-Ono (IL)

(73) Assignee: Kornit Digital Ltd., Rosh HaAyin (IL)

(21) Appl. No.: 18/577,317

(22) PCT Filed: Jul. 4, 2022
(86) PCT No.: PCT/IL2022/050709

§ 371 Date: Jan. 8, 2024

Related U.S. Application Data
(60) Provisional application No. 63/218,969, filed on Jul. 7, 2021.

(51) Int. Cl. D06N 3/00; D06B 11/00; D06B 23/02

(52) U.S. Cl. CPC D06N 3/0077; D06B 11/0093; D06B 23/026; D06N 3/0088

(57) ABSTRACT

A printed fabric comprises a textile substrate and a layer of ink-bearing binder printed on the textile substrate. The layer of ink-bearing binder is a fissured or broken layer of microscopic fragments. The binder film stiffens the texture of the textile, and breaking up of the film allows the softness of the original fabric to be substantially restored after the printing process.

### RELATED APPLICATION/S

This application claims the benefit of priority of U.S. Provisional Patent Application No. 63/218,969 filed on Jul. 7, 2021, the contents of which are incorporated herein by reference in their entirety.

### FIELD AND BACKGROUND OF THE INVENTION

The present invention, in some embodiments thereof, relates to mechanical softening of printed fabrics and, more particularly, but not exclusively, to the use of mechanical methods to ensure as far as possible that the softness or texture of the printed fabric or part of the fabric is the same as the unprinted fabric.

In the past, colored and patterned textile fabrics were made by weaving together different color threads. Today it is preferred to print onto the fabrics. However, a textile carrying print has a different feel to it than an unprinted textile. The feel is harder, stiffer, less soft than the unprinted textiles. Furthermore it is easy to distinguish printed from unprinted areas on a partly printed textile based on the relative softness of the areas.

The reason for the different feel is the makeup of the ink. The ink particles are carried in a binder and the binder forms a film on or in the textile which makes the textile surface stiffer. The binder cannot be dispensed with, as without the binder the coloring particles, the pigments, do not remain on the textile. A typical binder used with printing inks is a cross-linked polymer binder, and the printing ink may be applied using any kind of textile printing technique including screen printing and inkjet printing, to apply color, images and patterns to the underlying textile. The film that forms may be a continuous film of a printed image on the fabric or the film may be discontinuous, say in the case of partly printed fabric.

It is further noted that in some cases, say particularly in roll to roll printing there will not be a continuous film of ink over the entire fabric but rather spots of inks that do not form a continuous film. However, even as spots the film may still impact the hand feel and drape of the fabric.

Essentially the film, which is generally not continuous over the fabric, may be considered as binder ink in a cured state over the fabric. To be clear, the ink that is cured even may comprise small spots on the fabric.

In general printing may be of the textile web prior to its use in making garments, for example using what is known as roll-to-roll printing. However in other cases printing may be on garments that are already made up, say in the case of printing images on tee-shirts. Generally, in the former case the print is applied to the entire textile and in the latter case printing is limited to a specified area of the garment.

As explained, printing tends to stiffen the fabric, and in the known art, the fabric may be held in a stream of air, say in a tumble dryer to obtain softening. However this method is only partially effective.

### SUMMARY OF THE INVENTION

The present embodiments relate to operations carried out on a printed fabric to mechanically break up a binder film. For example, a method of breaking up the binder film may comprise cooling the textile after printing to a temperature which increases the brittleness of the binder and then mechanically breaking the binder film. Breaking may for example involve passing the printed textile between an arrangement of teeth, for example on rotating cogs.

The embodiments may further relate to a system in which the printed textile is suspended and conveyed through a cooling area and mechanically crushed.

The embodiments may further relate to a system in which the printed textile is suspended and conveyed through mechanical crushers. For example rotating cogs with interlocking teeth may carry out the mechanical crushing.

The embodiments may further relate to a conveyor system in which the printed textile is suspended and conveyed through a cooling area and a mechanical crusher which are combined so that crushing is carried out on the cooled textile. The textile may be cooled to a temperature around the glass transition point of the binder, so that the binder is more brittle and susceptible to the crushing.

The embodiments may further relate to a printed garment having a softness equivalent to that of the original unprinted textile.

According to an aspect of some embodiments of the present invention there is provided a fabric comprising:
a substrate;
a layer of ink-bearing binder printed on the substrate; and
the layer of ink-bearing binder being a fissured or broken layer of microscopic fragments.

In an embodiment, the substrate exhibits a first drape angle when forming a film prior to being broken and exhibits a second drape angle following breaking of the film, the second drape angle being greater than the first drape angle.

In an embodiment, the binder comprises a cross-linked polymer.

In an embodiment, the ink-bearing binder is applied on the textile substrate by inkjet printing.

In an embodiment, the layer of ink-bearing binder imparts selected coloring or a pattern or an image on the substrate.

According to a second aspect of the present invention there is provided a method of processing a fabric after printing, comprising:
printing onto the fabric using an ink-bearing binder;
curing the ink such that the ink-bearing binder forms a film on the fabric; and
mechanically fissuring or breaking the film.

The method may comprise cooling the fabric after printing and prior to the mechanically fissuring or breaking, such that the mechanically fissuring or breaking is carried out on a cooled printed fabric.

In an embodiment, the ink-bearing binder has a glass transition temperature—Tg—and wherein the fabric is cooled to be near to the Tg. The fabric may cooled to below the Tg.

The method may comprise:
suspending the fabric from a conveyor following the printing;
conveying the suspended fabric to a cooling area for the cooling; and
conveying the suspended fabric between toothed rotating rollers to achieve the mechanical fissuring or breaking.

In an embodiment, teeth of the toothed rotating rollers interlock to deform the fabric between the teeth.

The method may comprise forming microscopic fissures in the film during the deforming between the teeth.

In an embodiment, the toothed rotating rollers are located in the cooling area.

In an embodiment, the toothed rotating rollers are located after the cooling area.

In an embodiment, the cooling area comprises a first area cooled to a first temperature and a second area cooled to a second temperature.

In an embodiment, at least one rotating toothed roller includes an array of protrusions configured to form the microscopic cracks.

In an embodiment, at least one rotating toothed rollers includes an array of grooves configured to form the microscopic cracks.

In an embodiment, at least one rotating toothed roller is actively cooled.

In an embodiment, the cooling comprises cooling the printed fabric to a temperature below 5° C.

In an embodiment, the cooling comprises cooling the layer of fabric to a temperature below 0° C.

In an embodiment, the cooling comprises cooling the layer of printed material to a temperature that is less than 10° C. above the Tg.

The invention may further relate to any product obtained by the above methods.

According to a fourth aspect of the present invention there is provided a system for mechanically processing printed fabrics wherein the fabrics are printed with ink contained in a binder film, the system comprising:
a conveyor configured to convey the fabrics along a defined path, the fabrics being suspended; and
at least one mechanical crusher located in the defined path, the fabrics suspended from the conveyor, the mechanical crusher configured to crush the fabrics while the fabrics are drawn through by the conveyor, thereby to fissure or break up the binder film and soften the printed fabrics.

The system may comprise a cooling area, the cooling area located along the path, the cooling area configured to cool the printed fabrics.

The cooling area may be located in relation to the mechanical crusher to ensure that the crushing is carried out on the printed fabrics when cooled.

In the system, the binder film may have a glass transition temperature—Tg—and the fabric may be cooled to be near to the Tg.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram showing a cross section of a printed fabric in which ink-bearing binder is embedded in the fabric substrate and forms a stiff film according to the prior art;

FIG. 2 is a simplified diagram illustrating an embodiment of the present invention in which the ink bearing binder film is broken or cracked into microscopic pieces;

FIG. 3 is a simplified diagram showing a view from below of a drape test carried out to determine the softness of a sample of material;

FIG. 4 is a microscope view of printed fabric with microscopic fracturing of the binder film according to embodiments of the present invention;

FIG. 5 is a reference microscope view of prior art printed fabric with the binder film intact;

FIG. 6 is a simplified flow chart of a process for softening a printed fabric according to an embodiment of the present invention;

FIG. 7 is a simplified flow chart of a further process for softening a printed fabric according to an embodiment of the present invention;

FIG. 8 is a simplified flow chart of a yet further process for softening a printed fabric according to an embodiment of the present invention;

FIG. 9 is a simplified flow chart of a further process for softening a printed fabric according to an embodiment of the present invention;

FIG. 10 is a view showing two toothed rollers that may be used for mechanical breaking according to embodiments of the present invention; and

FIG. 11 is a simplified block diagram showing a system for softening printed fabric according to embodiments of the present invention.

### DESCRIPTION OF SPECIFIC EMBODIMENTS OF THE INVENTION

The present invention, in some embodiments thereof, relates to mechanical softening of printed fabrics and, more particularly, but not exclusively, to the use of mechanical methods to ensure as far as possible that the softness or texture of the printed fabric or part of the fabric is the same as the unprinted fabric.

The present embodiments relate to the softening of printed fabrics in which the printing ink uses polymer binders, and wherein the polymer binders create a stiff or otherwise unpleasant feel to the fabric.

The present embodiments may relate to a printed fabric comprises a textile substrate and a layer of ink-bearing binder printed on the textile substrate. The layer of ink-bearing binder is a broken or fissured layer of microscopic fragments. The binder film stiffens the texture of the textile, and breaking up of the film allows the softness of the original fabric to be substantially restored after the printing process.

The present embodiments may relate to a softening method of softening printed fabrics by applying physical and mechanical principles. The unpleasant feel of the printed fabric is caused by the binder component of the printed ink as mentioned and softening of the printed fabric is achieved in the present embodiments by breaking the film. The cross linked polymer binder of the ink creates a flexible film that becomes brittle (glassy) when cooled towards the glass transition temperature (herein Tg) and where the brittleness intensifies once Tg is passed.

In roll-to-roll processing, the mechanical breaking of the polymer film may be achieved simply by methods such as calendaring or transferring the fabric through a set of engraved or toothed rollers. However, performing the mechanical breaking at cool temperatures enhances the effectiveness, and particularly if the temperature is cooled to around the Tg temperature of the particular binder being used, then the effectiveness of mechanically breaking the binder film is enhanced due to the increased brittleness caused by the temperature.

The embodiments may further relate to a conveyor system in which the printed textile is suspended and conveyed through a cooling area and/or through rotating cogs, so that the film is made brittle and then crushed. The rotating cogs may be located in the cooling area and cooling may be achieved by refrigeration or air conditioning. In particular, the cooling may be combined with drying the air, and a feature for drying air is often available in air conditioning plant.

The embodiments may further relate to a printed garment having a softness equivalent to that of the original unprinted textile.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

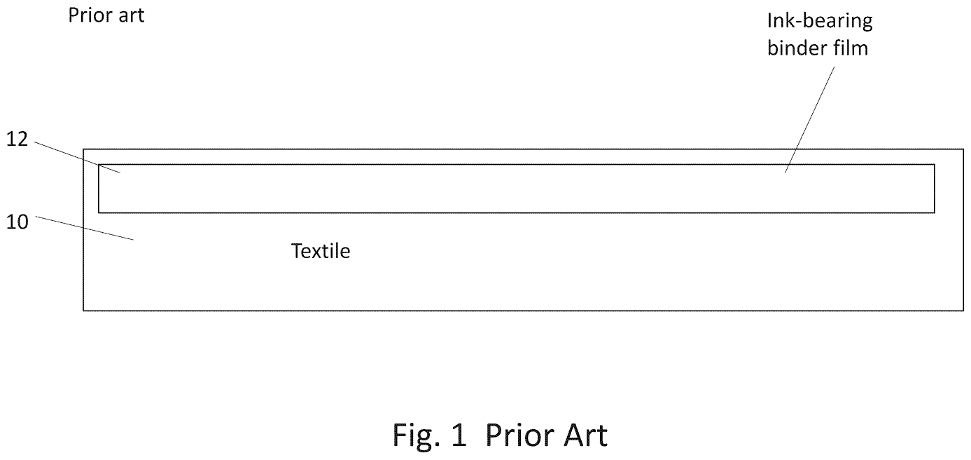

Referring now to the drawings, FIG. 1 illustrates a fabric 10 where the fabric forms a substrate that is printed on. The printing results in a layer 12 of binder substance on or absorbed into the substrate that carries the dyes or inks that provide color. FIG. 1 schematically shows the binder as a film which retains its integrity and thus takes away from the feel of the fabric itself. It is noted that the fabric is not limited to textile substrates, but fabrics such as felt may also be included.

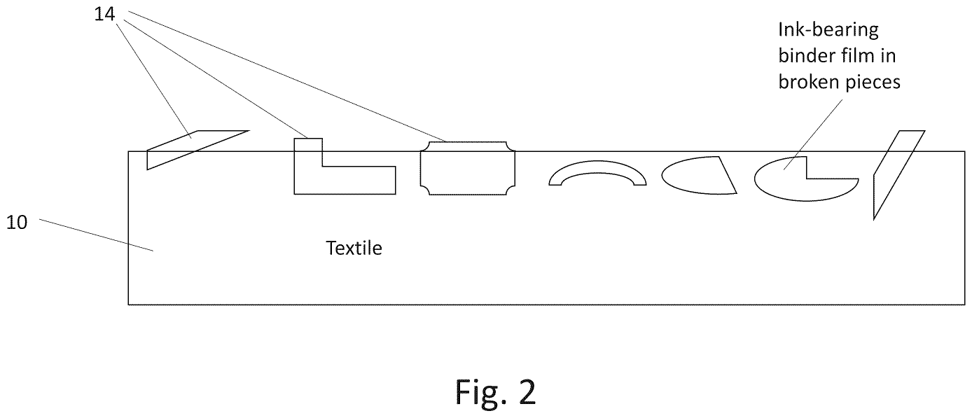

FIG. 2 illustrates a fabric after printing and modified according to the present embodiments. A fabric 10 has a layer of ink-bearing binder printed on the fabric as a substrate. However, in accordance with the present embodiments, the layer of ink-bearing binder is fissured or actually broken up into microscopic fragments 14. The microscopic fragments retain their integrity and thus continue to keep the ink or dye particles in place, however there is no continuous film so that the feel of the fabric is no longer overwhelmed by the feel of the film.

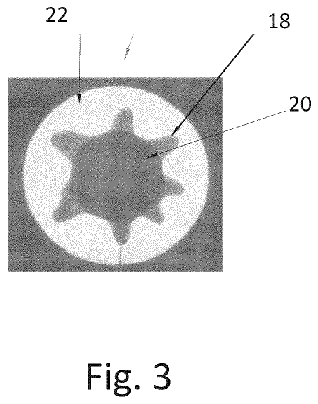

Reference is now made to FIG. 3, which illustrates what is known as the drape test. The drape test is a test for the softness of the fabric, in which a circular specimen of the fabric is held between two horizontal discs which are smaller than the specimen, so that an annular outer ring 18 of the specimen hangs or drapes from the lower disc 20, and the extent to which the sample extends outwardly from the disk and fills annular ring 22 is used as a measure of the softness.

Three different samples were tested, a sample of the pure fabric, a sample immediately following printing and a sample when the film is broken into microscopic fragments in accordance with the present embodiments.

The textile substrate exhibits one drape level when forming a film prior to being broken and exhibits a second drape level following breaking of the film. The second drape level is smaller than the first drape level and may be close to the drape level of the original unprinted fabric. In a test, a polyester fabric gave a drape level of 28% prior to printing. The drape level went up to 40% following printing and then was reduced to 30%, after applying cooling and crushing according to the present embodiments.

The binder forming the film may be typically be a cross-linked polymer, and the ink-or-pigment bearing binder is applied on the substrate by inkjet printing.

The ink or pigment in the binder may impart selected coloring or a pattern or an image to the textile or other fabric. The ink or pigment and binder may be applied to the fabric by inkjet or other digital printing or by screen printing.

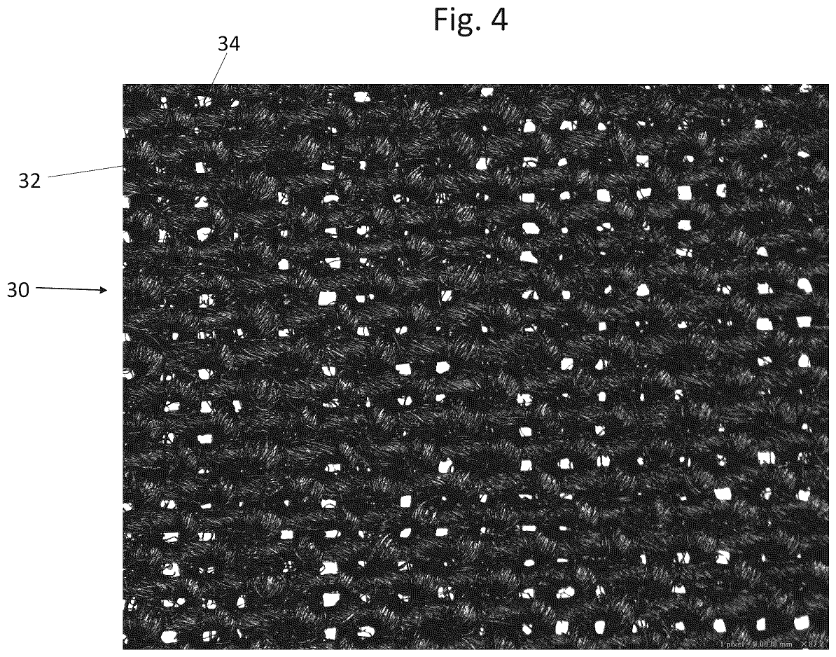

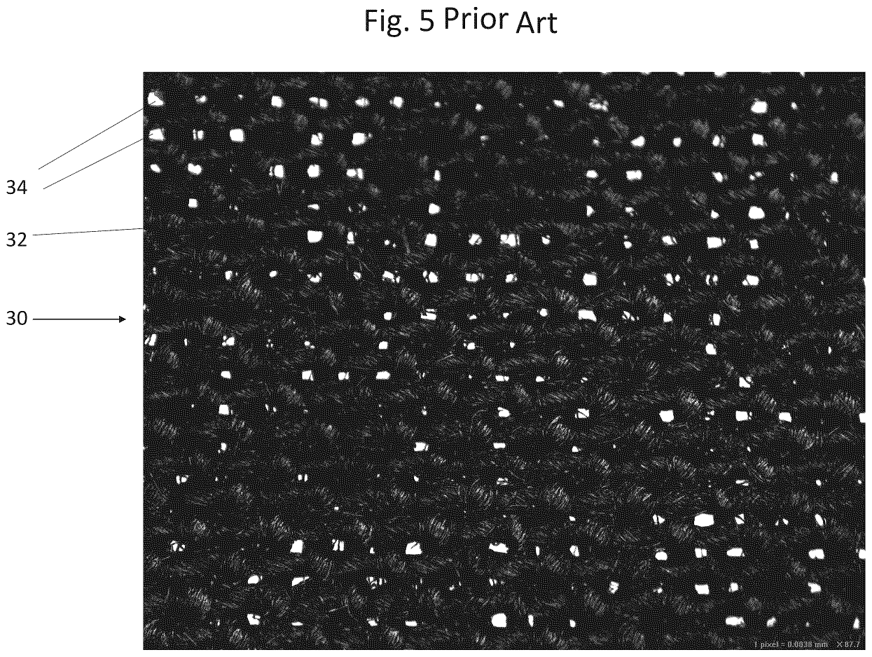

FIGS. 4 and 5 are two microscope views of a textile fabric which has been printed on. The fabric 30 includes textile fibers 32 and patches of film 34 are seen between the fibers. In FIG. 4, the binder appears between the fibers and is broken into microscopic pieces. In FIG. 5 no special treatment has been applied to the fibers and the film is much more complete and pieces of film with multiple breaks are less visible, although it has to be borne in mind that the difference is not easy to see as the film is absorbed into the fibers of the textile.

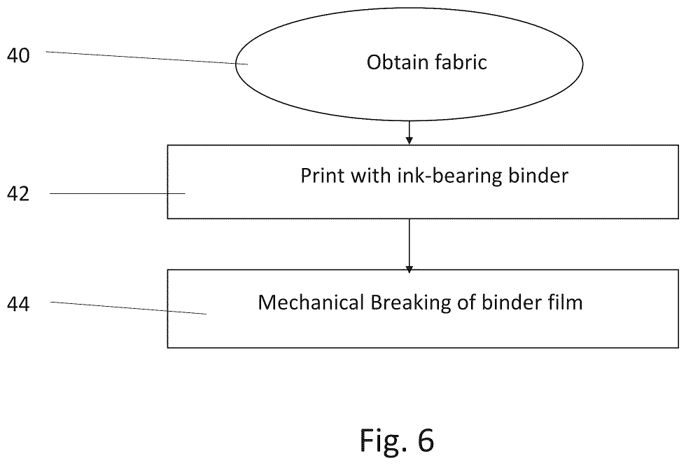

Reference is now made to FIG. 6, which illustrates a method of softening a fabric after printing in order to provide the microscopic structure of the binder as illustrated in FIG. 2. The fabric, obtained in 40, is then printed—42—with a typical printing ink that is suitable for fabrics, having ink or dye particles in a binder. The binder forms a film on the fabric after printing. In stage 44, mechanical breaking is applied to the fabric to break up the film into particles.

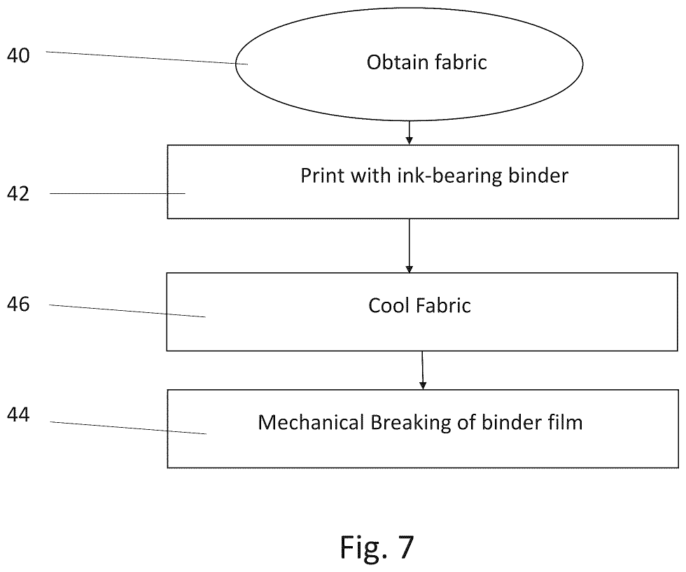

Reference is now made to FIG. 7, which illustrates a variation of the method of FIG. 6 in which the fabric is cooled prior to applying mechanical breaking. The fabric is obtained as before—40, and is printed on—42. Then, when the ink is dry, the fabric is cooled 46, with the effect that the binder becomes more brittle. Thus when mechanical breaking is applied—44—the brittleness makes the mechanical effect on the film stronger. In embodiments, cooling may be provided by a stream of cool dry air, the air being dried so that moisture does not land on the fabric during the process. Cooling may for example be to 15 or 10 or 5 degrees Celsius or to refrigeration or to freezing temperatures depending on the binder.

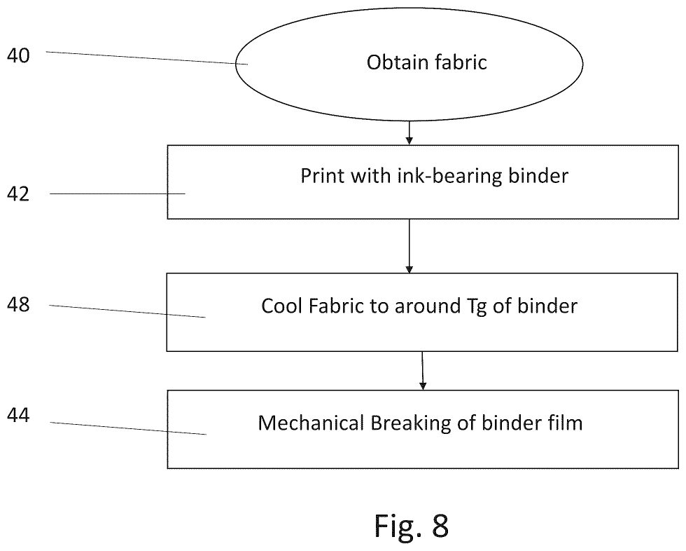

Reference is now made to FIG. 8, which illustrates a variation of the method of FIG. 7 in which the ink-bearing binder has a glass transition temperature—Tg—a temperature at which a transition into a more brittle state takes place. Parts 40, 42 and 44 are the same as in the previous embodiments but in 48, the fabric is cooled to be near to Tg. The fabric may be cooled to slightly above or at Tg, or to below Tg. Thus the fabric may be cooled to 10 or 5 degrees Celsius above Tg or to Tg itself or to 5 or 10 degrees below Tg or to any other temperatures that seems appropriate to get the softness as close to the original softness of the material.

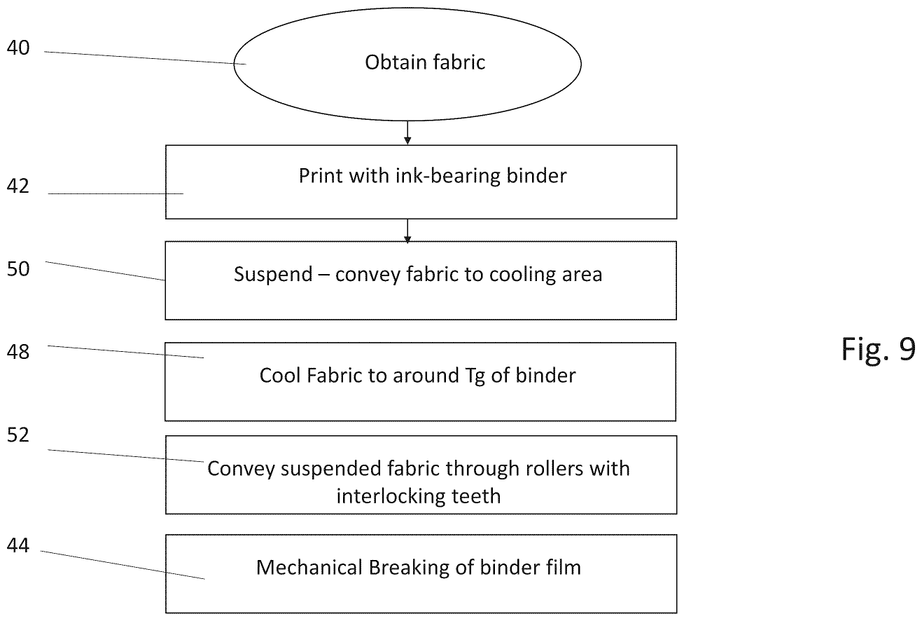

Reference is now made to FIG. 9, which is a flow chart showing a further embodiment of the present invention. The fabric is obtained 40 and printed on 42 as before. The printed fabric is suspended from a conveyor and then conveyed to a cooling area 50. At the cooling area the fabric is cooled 48, for example to around Tg as discussed above, and then the cooled fabric is conveyed to pass 52 between a pair of rotating rollers. The rollers have teeth which interlock and trap the fabric between them, and thus mechanically break the film as the fabric passes between the rotating rollers 44. The teeth of the toothed rotating rollers interlock to deform the fabric between the teeth so as to fissure the film and the teeth may break the film into microscopic pieces.

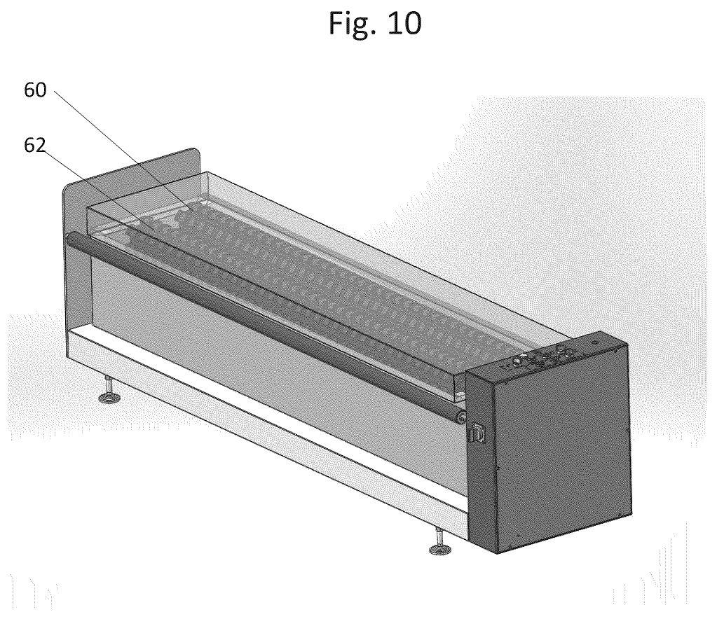

Reference is now made to FIG. 10 which illustrates first and second rollers 60 and 62 with interlocking teeth. The suspended fabric or textile is passed between the rollers which rotate. The teeth may be an array of protrusions. In another embodiment, the teeth may in fact be grooves that interlock with associated ridges to have the same effect. In an embodiment, the toothed rotating rollers are located in the cooling area. In an embodiment, the cooling area comprises a first area cooled to a first temperature and a second area cooled to a second temperature.

In an embodiment, one or both of the rollers may be actively cooled, and active cooling of the rollers may be additionally to or instead of a cooling area.

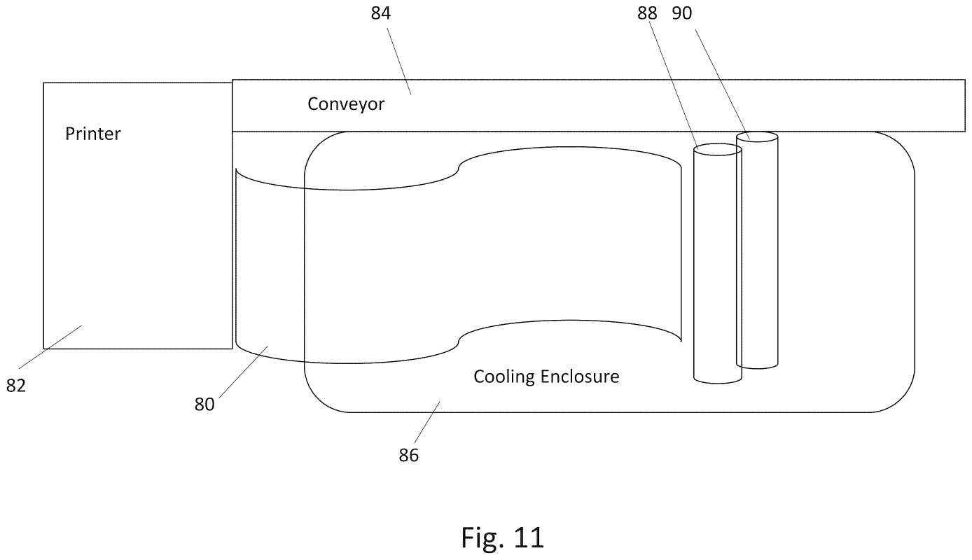

Reference is now made to FIG. 11, which is a simplified diagram showing a system for mechanically softening printed fabrics wherein the fabrics are printed with ink contained in a binder film. The fabric 80 emerges from printer 82 and is suspended from conveyor 84 to travel in a defined path through the system. The fabric enters cooling enclosure 86 where it is cooled according to any of the embodiments discussed hereinabove. The cooling enclosure may, as discussed, use dry cool air. The fabric then arrives at a location for mechanical breaking of the film. In an embodiment a calendar may be used, or alternatively two rollers 88 and 90 may be used, so that the suspended fabric passes between the rollers. The rollers may have interlocking teeth so that the fabric is stretched and deformed between the teeth as the rollers rotate to crush and break the binder film.

In an embodiment, the cooling area may be provided with different parts each set to provide different temperatures. Thus the temperature may fall gradually towards the rollers, or may fall in stepped manner, having two or more steps.

The crushing process may target the binder film, which is specifically what imparts the feeling of stiffness to the printed fabric. The crushing process provides a series of fissures to the film, which makes the film break up sufficiently that the dominating contribution to the texture is the fabric and not the film.

As illustrated, fabric in rolls is printed in roll-to-roll processing and then the printed fabric as a web is fed through toothed rollers. Mechanical breaking of the polymer film may be achieved by methods such as calendaring or transferring the fabric through a set of toothed rollers. The toothed rollers crush the material, forcing it to stretch and deform as it passes through deep gaps between the teeth of the opposing rollers. The breaking process, as discussed, is carried out while the temperature of the fabric is cooled to around the Tg temperature, which enhances the effectiveness of the breaking process by increasing the brittleness of the binder film.

However the invention is not limited to roll to roll printing and may also be applied to printing on garments such as t-shirts, which may also be passed between rollers after printing.

It is expected that during the life of a patent maturing from this application many relevant textile ink and printing technologies will be developed and the scopes of the corresponding and other terms herein are intended to include all such new technologies a priori.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A fabric comprising:
a substrate;
a layer of ink-bearing binder printed on said substrate; and
the layer of ink-bearing binder being a fissured or broken layer of microscopic fragments.

2. The fabric of claim 1, wherein the substrate exhibits a first drape angle when forming a film prior to being broken and exhibits a second drape angle following breaking of said film, said second drape angle being greater than said first drape angle.

3. The fabric of claim 1, wherein said ink-bearing binder comprises a cross-linked polymer, or wherein said ink-bearing binder is applied on said textile substrate by inkjet printing, or wherein said layer of ink-bearing binder imparts selected coloring or a pattern or an image on said substrate.

4-5. (canceled)

6. A method of processing a fabric after printing, comprising:
printing onto the fabric using an ink-bearing binder;
curing the ink such that the ink-bearing binder forms a film on said fabric; and
mechanically fissuring or breaking said film.

7. The method of claim 6, comprising cooling said fabric after printing and prior to said mechanically fissuring or breaking, such that said mechanically fissuring or breaking is carried out on a cooled printed fabric.

8. The method of claim 7, wherein said ink-bearing binder has a glass transition temperature—Tg—and wherein said fabric is cooled to be near to said Tg, or wherein said fabric is cooled to be below said Tg.

9. (canceled)

10. The method of claim 6, comprising:
suspending said fabric from a conveyor following said printing;
conveying said suspended fabric to a cooling area for said cooling; and
conveying said suspended fabric between toothed rotating rollers to achieve said mechanical fissuring or breaking.

11. The method of claim 10, wherein teeth of said toothed rotating rollers interlock to deform said fabric between said teeth.

12. The method of claim 11, comprising forming microscopic fissures in said film during said deforming between said teeth.

13. The method of claim 10, wherein said toothed rotating rollers are located in said cooling area, or wherein said toothed rotating rollers are located after said cooling area.

14. (canceled)

15. The method of claim 10, wherein said cooling area comprises a first area cooled to a first temperature and a second area cooled to a second temperature.

16. The method of claim 12, wherein at least one roller of said at least one pair of rotating toothed rollers includes an array of protrusions or an array of grooves, the array configured to form said microscopic cracks.

17. (canceled)

18. The method of claim 10, wherein at least one roller of said at least one pair of rotating toothed rollers is actively cooled.

19. The method of claim 7, wherein said cooling comprises cooling said printed layer of fabric to a temperature below 5° C. or to a temperature below 0° C., or to a temperature that is less than 10° C. above said Tg.

20-22. (canceled)

23. A system for mechanically processing printed fabrics wherein the fabrics are printed with ink contained in a binder film, the system comprising:
a conveyor configured to convey the fabrics along a defined path, the fabrics being suspended; and
at least one mechanical crusher located in said defined path, the fabrics suspended from the conveyor, the mechanical crusher configured to crush the fabrics while the fabrics are drawn through by the conveyor, thereby to fissure or break up the binder film and soften the printed fabrics.

24. The system of claim 23, further comprising a cooling area, the cooling area located along said path, the cooling area configured to cool the printed fabrics, or wherein said cooling area is located in relation to said mechanical crusher to ensure that said crushing is carried out on the printed fabrics when cooled.

25. (canceled)

26. The system of claim 23, wherein said binder film has a glass transition temperature—Tg—and wherein said fabric is cooled to be near to said Tg, or wherein said cooling area is configured to cool said fabric to below said Tg.

27. (canceled)

28. The system of claim 23, wherein said mechanical crusher comprise rotating toothed rollers.

29. The system of claim 28, wherein teeth of said toothed rotating rollers interlock to deform said fabric between said teeth, or wherein said interlocking teeth are configured to form fissures in said film or to break said film into microscopic pieces during said deforming between said teeth.

30. (canceled)

31. The system of claim 29, wherein at least one roller of at least one pair of rotating toothed rollers includes an array of protrusions configured to form said fissures or microscopic pieces, or wherein at least one roller of at least one pair of rotating toothed rollers includes an array of grooves configured to form said fissures or microscopic pieces.

32. (canceled)

33. The system of claim 28, wherein at least one roller of said at least one pair of rotating toothed rollers is actively cooled, or wherein said toothed rotating rollers are located in or after said cooling area.

34. (canceled)

35. The system of claim 23, wherein said cooling area comprises a first area cooled to a first temperature and a second area cooled to a second temperature.

36. The system of claim 23, wherein said cooling area is configured to cool said layer of fabric to a temperature below 0° C., or wherein said cooling area is configured to cool said layer of printed material to a temperature that is less than 5° C. above said Tg, or wherein said cooling area is configured to provide dry air.

37-38. (canceled)
